(19) United States
(12) Patent Application Publication
(10) Pub. No.: US 2008/0082335 A1
(43) Pub. Date: Apr. 3, 2008

(54) CONVERSION OF ALPHABETIC WORDS INTO A PLURALITY OF INDEPENDENT SPELLINGS

(76) Inventor: Howard Engelsen, Palm Beach Gardens, FL (US)

Correspondence Address: CUENOT & FORSYTHE, L.L.C., 12230 FOREST HILL BLVD., SUITE 120, WELLINGTON, FL, 33414, US

(21) Appl. No.: 11/536,272

(22) Filed: Sep. 28, 2006

(51) Int. Cl. G10L 15/04

(52) U.S. Cl. 704/254

(57) ABSTRACT

A method and a system for automatically converting alphabetic words into a plurality of independent spellings. The method can include parsing textual input to identify at least one word and converting the word into a first word object having a first spelling including letter objects. The method also can include converting the word into a second word object having a second spelling including phonetic objects, each of the phonetic objects correlating to at least one of the letter objects. Further, the first word object and the second word object can be presented in a visual field such that each of the phonetic objects is visually associated with the letter object to which it correlates.

### BACKGROUND OF THE INVENTION

For a typical child, the process of learning to read and write usually begins during the pre-school years or kindergarten. Using conventional teaching methods, a child initially learns to identify the letters of the alphabet. Then, beginning with short two and three letter words, the child is taught to string together the sounds of the letters to identify words. Once the child has become proficient at reading short words, the process can be expanded to teach the child to sound out and spell longer words, eventually leading to reading and writing. Unfortunately, teaching a child to read and write using conventional methods can be a lengthy process. It is not until about the third grade that a typical child becomes relatively proficient at reading.

Symbols that are recognizable to children are sometimes used to facilitate the learning process. For example, a pictograph of an apple can be associated with the letter “a,” a pictograph of an egg can be associated with the letter “e,” and a pictograph of an umbrella can be associated with the letter “u.” To generate learning materials that include such pictographs can be very costly, however, due to the complexity in correctly associating the pictographs with the letters. Indeed, such processes are typically performed quasi-manually using a graphics application and can be very labor intensive.

### SUMMARY OF THE INVENTION

The present invention relates to a method for automatically converting alphabetic words into a plurality of independent spellings. The method can include parsing textual input to identify at least one word and converting the word into a first word object having a first spelling including letter objects. The method also can include converting the word into a second word object having a second spelling including phonetic objects, each of the phonetic objects correlating to at least one of the letter objects. Further, the first word object and the second word object can be presented in a visual field such that each of the phonetic objects is visually associated with the letter object to which it correlates.

The present invention also relates to a processor that parses textual input to identify at least one word. The processor can convert the word into a first word object having a first spelling including letter objects, and convert the word into a second word object having a second spelling including phonetic objects. Each of the phonetic objects can correlate to at least one of the letter objects. At least one output device can present the first word object and the second word object in a visual field such that each of the phonetic objects is visually associated with the letter object to which it correlates.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a textual conversion system that is useful for understanding the present invention;

FIG. 2 depicts conversions of textual input that are useful for understanding the present invention;

FIG. 3 depicts another arrangement of the conversions of textual input presented in FIG. 2;

FIG. 4 depicts additional conversions of textual input that are useful for understanding the present invention; and

FIG. 5 depicts a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for receiving textual input and automatically converting at least one alphabetic word (hereinafter “word”) contained in the textual input into a plurality of related words having independent spellings. For example, the alphabetic word can be converted into a first word having a first spelling comprising letter objects, and converted into a second word having a second spelling comprising phonetic objects. The related words then can be presented in a visual field such that correlating portions of the related words are visually associated. For instance, each of the phonetic objects can be presented in a manner in which they are associated with their corresponding letter objects.

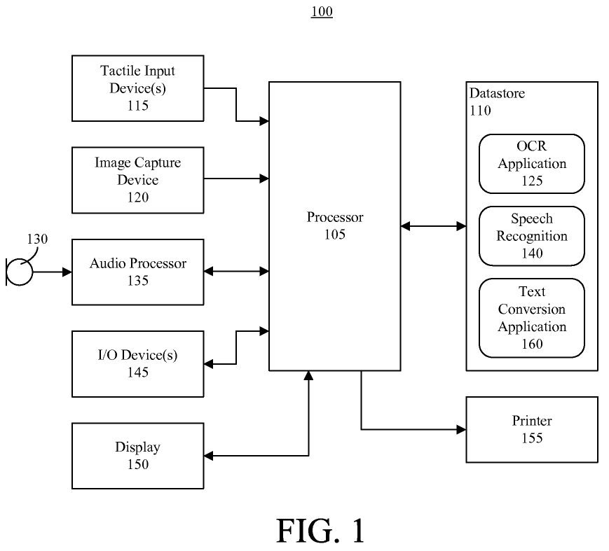

FIG. 1 depicts a textual conversion system (hereinafter “system”) 100 that is useful for understanding the present invention. The system 100 can be embodied as a computer (e.g. personal computer, server, workstation, mobile computer, etc.) or an application specific textual conversion device. The system 100 can include a processor 105. The processor 105 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The system 100 can include a datastore 110. The datastore 110 can include one or more storage devices, each of which can include a magnetic storage medium, an electronic storage medium, an optical storage medium, a magneto-optical storage medium, and/or any other storage medium suitable for storing digital information. In one arrangement, the datastore 110 can be integrated into the processor 105.

One or more user interface devices can be provided with the system 100. For example, the system 100 can include tactile input devices 115, such as a keyboard and/or a mouse. The tactile input devices 115 can receive tactile user inputs to enter or select textual input containing words that are to be converted in accordance with the methods and process described herein.

The system 100 also can include an image capture device 120, for instance a scanner. The image capture device 120 can capture images of text to be entered into the system 100 for conversion. An optical character recognition (OCR) application 125 can be provided to convert text contained in captured images into textual input. The OCR application 125 can be contained on the datastore 110 or in any other suitable storage device.

An audio input transducer (e.g. microphone) 130 also can be provided to detect acoustic signals, such as spoken utterances, and generate corresponding audio signals. The audio input transducer 130 can be communicatively linked to an audio processor 135, which can process the audio signals as required for processing by the processor 105. For example, the audio processor 135 can include an analog to digital converter (ADC) to convert an analog audio signal into a digital audio signal, and equalization components to equalize the audio signal. The audio processor 135 can forward the audio signals to the processor 105, which can execute a speech recognition application 140 to convert the audio signals into textual input.

Additional input/output devices 145 also can be provided to receive data containing textual input or data from which textual input may be generated. Examples of such devices 145 can include, but are not limited to, a network adapter, a transceiver, a communications bus (e.g. universal serial bus), communications ports, and the like. The input/output devices 145 also can receive data generated by the processor 105.

The system 100 also can include an output device, such as display 150, in which a visual field can be presented. In one arrangement, the display 150 can be a touch screen which can receive tactile inputs to enter the textual input. In addition to, or in lieu of, the display 150, the system 100 also can include a printer 155 as an output device. The printer 155 can print the visual field onto paper or any other suitable print medium.

A text conversion application 160 can be contained on the datastore 110. The text conversion application 160 can be executed by the processor 105 to implement the methods and process described herein. For example, the text conversion application 160 can receive textual input from the tactile input devices 115, the OCR application 125, the speech recognition application 140, the input/output devices 145, the display 150 or any other device suitable for providing textual input. The text conversion application 160 then can process the textual input to identify words contained in the textual input and convert such words into a plurality of word objects. The word objects then can be communicated to the input/output devices 145, the display 150 and/or the printer 155 for presentation in a visual field. In particular, word objects that correlate to a particular word can be presented in a manner in which they are visually associated.

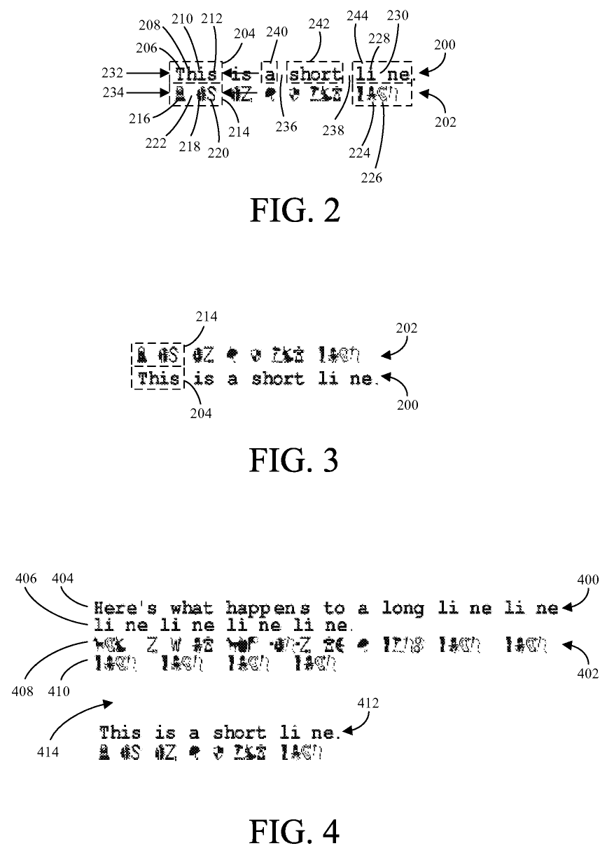

FIG. 2 depicts conversions 200, 202 of textual input “This is a short line” in accordance with the inventive arrangements described herein. For each word contained in the textual input, a plurality of word objects can be generated. For instance, for the word “This,” a first word object 204 having a spelling comprising letter objects 206, 208, 210, 212 can be generated, and a second word object 214 having a spelling comprising phonetic objects 216, 218, 220 can be generated. Notably, the phonetic objects 216-220 can take various forms to facilitate comprehension and the invention is not limited in this regard.

The second word object 214 can be positioned in the visual field (e.g. on a display or in print) such that it is visually associated with the first word object 204. For example, the second word object 214 can be positioned over, under or beside the first word object 204. Further, the phonetic objects 216, 218, 220 can be positioned so as to be associated with the letter objects 206, 208, 210, 212 to which they correlate. For example, the phonetic object 216 can correlate to the combination of the letter objects 206, 208 (“Th”), and thus can be positioned so as to convey such correlation. In the example, the phonetic object 216 is positioned directly below the letter object 206. However, the phonetic object 216 also may be positioned above or beside the letter object 206, or above, below or beside the letter object 208. Still, the phonetic object 216 can be positioned in any other manner suitable to convey the correlation between the phonetic object 216 and the letter objects 206, 208 and the invention is not limited in this regard.

The phonetic object 218 can correlate to the letter object 210 and the phonetic object 220 can correlate to the letter object 212. Accordingly, in the example, the phonetic object 218 can be positioned below the letter object 210 and the phonetic object 220 can be positioned below the letter object 212. A blank phonetic object 222 can be aligned with the letter object 208, which can indicate that the letter object 208 is to be combined with its adjacent letter object 206 for the purposes of pronunciation. In this example, the phonetic object 216 can represent the sound produced when uttering “th.”

As pronounced, some words are formed using sounds that are not indicated by their conventional spelling. Nonetheless, when teaching a child to read, it can be beneficial to indicate such sounds to facilitate the child's grasp of the words. For example, the word “line” is typically pronounced by uttering two distinct sounds represented by the letter “i.” Accordingly, two phonetic objects 224, 226 can be associated with the “i” letter object 228. In the word object 244, the letter object 228 can be followed by a blank letter object 230. The blank letter object 230 can indicate that both phonetic objects 224, 226 are associated with the letter object 228.

To facilitate automated conversion of input text into the conversions 200, 202, at least one physical dimension of the first word object 204 can be substantially equivalent to at least one physical dimension of the second word object 214. For example, in an arrangement in which the first and second word objects 204, 214 are vertically aligned, a width 232 of the first word object 204 can be equal to a width 234 of the second word object 214. Accordingly, as the words are parsed from the textual input to generate the first and second word objects 204, 214, such word objects 204, 214 can be sequentially positioned to form the conversions 200, 202 without the need to perform additional alignment steps. Of course, spaces 236, 238 can be inserted between adjacent word objects 240, 242, 244 to distinguish individual words.

In an alternative embodiment, a width of each of the phonetic objects 216, 218, 220 can be substantially equivalent to a width of the letter objects 206, 208, 210, 212 to which they correspond. Since the phonetic object 216 corresponds to two letter objects 206, 208, the blank phonetic object 222 can be inserted between the phonetic object 216 and the phonetic object 218, and can have a width equal to the letter object 208. In another arrangement, the width of the phonetic object 216 can be equal to the combined width of the letter objects 206, 208.

In one aspect of the inventive arrangements described herein, after individual words have been parsed from the textual input, the first and second word objects 204, 214 that correspond to the parsed words can be selected from one or more data objects, such as data files or data tables. For example, if a first word parsed from the textual input sentence is “this,” the word “this” can be processed to identify and select the first word object 204 and the second word object 214. For instance, structured query language (SQL) can be implemented to generate a query that performs the selection of the first and second word objects 204, 214 from the data file(s) and/or data table(s). Notwithstanding, the selection of the first and second word objects 204, 214 can be performed in any other suitable manner. Because the first word object 204 is a first word of a sentence, a version of that word object can be selected in which its first letter “T” is capitalized. A version of the word object 204 also can be available in which the letter “t” is not capitalized. Such version can be selected if the parsed word is not the first word in the textual input sentence.

The plurality of word objects 204, 214 that correspond to any word can be generated to have at least one dimensional parameter that is substantially the same. For example, for a particular font size, the word objects 204, 214 that correlate to a particular word each can have the same width. The dimensional parameters can be dynamically variable based on the font size that is selected so long as such dimensional variation is applied substantially equally to each of the word objects 204, 214.

In an alternate arrangement, at least one dimensional parameter of each of the phonetic objects 216, 222, 218, 220 can be substantially equivalent to a dimensional parameter of one or more of the letter objects 206, 208, 210, 212 to which the phonetic objects 216, 222, 218, 220 correspond. For example, a width of the phonetic object 216 can be substantially the same as the width of the letter object 206, a width of the blank phonetic object 222 can be substantially the same as the width of the letter object 208, and so on. Similarly, the width of the phonetic object 224 can be substantially the same as the width of the letter object 228, and the width of the phonetic object 226 can be substantially the same as the width of the blank letter object 230. Again, the dimensional parameters can be dynamically variable based on the font size that is selected so long as such dimensional variation is applied substantially equally to each of the letter objects 206, 208, 210, 212 and their corresponding phonetic objects 216, 222, 218, 220.

In one aspect of the invention, the first word objects 204 can be presented with visual effects that distinguish the first word objects 204 from the second word objects 214. For example, the letter objects 206, 208, 210, 212 can be presented with a font color that is different than the color in which the phonetic objects 216, 218, 220 are presented. In another arrangement, the letter objects 206, 208, 210, 212 can be presented with a font that, in comparison to the phonetic objects 216, 218, 220, contrasts less with a background of the visual field in which the first and second word objects 204, 214 are presented. For example, the letter objects 206, 208, 210, 212 can be presented in a shade of gray while the phonetic objects 216, 218, 220 are presented in black. In yet another arrangement, the word objects 204 can be underlined. Still, any other suitable effects can be applied to the first word objects 204, the second word objects 214, the letter objects 206, 208, 210, 212 and or the objects 216, 218, 220, and the invention is not limited in this regard.

In addition to the first and second word objects 204, 214, pictures, objects or symbols can be presented in the visual field. Such pictures, objects or symbols can be presented above, below, beside and/or between the first word objects 204 and the second word objects 214, or positioned in the visual field in any other suitable manner. In one arrangement, the pictures, objects or symbols can be pictorial representations of the first and second word objects 204, 214.

FIG. 3 depicts another arrangement of the conversions of textual input presented in FIG. 2. In particular, the conversions 200, 202 of textual input are depicted in an arrangement in which the first word objects 204 are presented below the second word objects 214. Still, the first and second word objects 204, 214 can be presented in any other manner suitable for associating corresponding word objects 204, 214 and the invention is not limited in this regard.

FIG. 4 depicts additional conversions 400, 402 of textual input that are useful for understanding the present invention. When the conversion 400 of a sentence extends in length so as to require a plurality of lines 404, 406 to be displayed in the visual field in order to present the entire sentence, such lines 404, 406 can be adjacently positioned (e.g. the second line 406 can be presented immediately below the first line 404). In this arrangement, lines 408, 410 also can be adjacently positioned. Further, the group of lines 408, 410 presenting the phonetic conversion 402 of the textual input sentence can be positioned adjacently to the group of lines 404, 406, thereby indicating that the conversions 400, 402 are generated from the same textual input sentence.

A second letter object conversion 412 for a next textual input sentence can be positioned below the conversion 402, and an indicator can be provided to indicate that the second letter object conversion 412 is not associated with the conversion 402. For example, a graphic or additional blank space 414 can be provided between the second letter object conversion and the conversion 402.

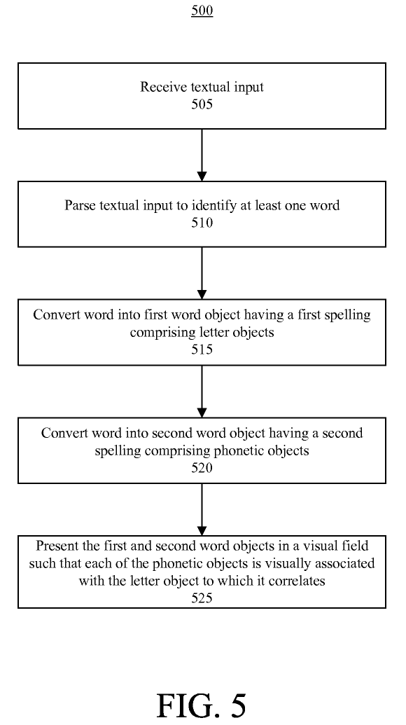

FIG. 5 depicts a flowchart presenting a method 500 that is useful for understanding the present invention. Beginning at step 505, textual input can be received. At step 510, the textual input can be parsed to identify at least one word. Proceeding to step 515, the word can be converted into a first word object having a first spelling comprising letter objects. Continuing to step 520, the word also can be converted into a second word object having a second spelling comprising phonetic objects. At step 525, the first and second word objects can be presented in a visual field such that each of the phonetic objects is visually associated with the letter object to which it correlates.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for automatically converting alphabetic words into a plurality of independent spellings, comprising:
parsing textual input to identify at least one word;
converting the word into a first word object having a first spelling comprising letter objects;
converting the word into a second word object having a second spelling comprising phonetic objects, each of the phonetic objects correlating to at least one of the letter objects; and
presenting the first word object and the second word object in a visual field such that each of the phonetic objects is visually associated with the letter object to which it correlates.

2. The method of claim 1, wherein converting the word into the first word object comprises selecting the first word object from at least one data object selected from the group consisting of a data table and a data file, the data object associating the word with the first word object.

3. The method of claim 2, wherein the first word object comprises at least one letter object.

4. The method of claim 1, wherein converting the word into the second word object comprises selecting the second word object from at least one data object selected from the group consisting of a data table and a data file, the data object associating the word with the second word object.

5. The method of claim 4, wherein the second word object comprises at least one phonetic object.

6. The method of claim 1, wherein presenting the first word object and the second word object in the visual field comprises presenting the second word object below the first word object.

7. The method of claim 1, wherein presenting the first word object and the second word object in the visual field comprises presenting the first word object below the second word object.

8. The method of claim 1, wherein presenting the first word object and the second word object comprises presenting the first word object with at least one visual effect that visually distinguishes the first word object from the second word object.

9. The method of claim 1, further comprising receiving the textual input from a speech recognition application.

10. The method of claim 1, further comprising receiving the textual input from an optical character recognition application.

11. The method of claim 1, wherein presenting the first word object and the second word object in the visual field comprises presenting the first word object and the second word object on a display.

12. The method of claim 1, wherein presenting the first word object and the second word object in the visual field comprises presenting the first word object and the second word object on a print medium.

13. A machine readable storage, having stored thereon a computer program having a plurality of code sections comprising:
code for parsing textual input to identify at least one word;
code for converting the word into a first word object having a first spelling comprising letter objects;
code for converting the word into a second word object having a second spelling comprising phonetic objects, each of the phonetic objects correlating to at least one of the letter objects; and
code for presenting the first word object and the second word object in a visual field such that each of the phonetic objects is visually associated with the letter object to which it correlates.

14. The machine readable storage of claim 13, wherein the code for converting the word into the first word object comprises code for selecting the first word object from at least one data object selected from the group consisting of a data table and a data file, the data object associating the word with the first word object.

15. The machine readable storage of claim 14, wherein the first word object comprises at least one letter object.

16. The machine readable storage of claim 13, wherein the code for converting the word into the second word object comprises code for selecting the second word object from at least one data object selected from the group consisting of a data table and a data file, the data object associating the word with the second word object.

17. The machine readable storage of claim 16, wherein the second word object comprises at least one phonetic object.

18. The machine readable storage of claim 13, wherein the code for presenting the first word object and the second word object comprises code for presenting the first word object with at least one visual effect that visually distinguishes the first word object from the second word object.

19. A system comprising:
a processor that parses textual input to identify at least one word, converts the word into a first word object having a first spelling comprising letter objects, and converts the word into a second word object having a second spelling comprising phonetic objects, each of the phonetic objects correlating to at least one of the letter objects; and
at least one output device that presents the first word object and the second word object in a visual field such that each of the phonetic objects is visually associated with the letter object to which it correlates.

20. The system of claim 19, wherein the output device presents the first word object with at least one visual effect that visually distinguishes the first word object from the second word object.
